(19) United States
(12) Patent Application Publication
(10) Pub. No.: US 2011/0052278 A1
(43) Pub. Date: Mar. 3, 2011

(54) FUSING UNIT AND IMAGE FORMING APPARATUS HAVING THE SAME

(75) Inventors: Heung Sup Park, Suwon-si (KR); Kyoung Hwan Kim, Yongin-si (KR); Seung Min Ryu, Yongin-si (KR); Jin Yong Lee, Suwon-si (KR); Seung Hoon Kal, Suwon-si (KR); Hyo Keun Park, Yongin-si (KR)

(73) Assignee: Samsung Electronics Co., Ltd, Suwon-si (KR)

(21) Appl. No.: 12/871,131

(22) Filed: Aug. 30, 2010

(30) Foreign Application Priority Data
Sep. 2, 2009 (KR) 2009-0082414

(51) Int. Cl. G03G 15/20

(52) U.S. Cl. 399/328

(57) ABSTRACT

A fusing unit which includes a pressure member to be elastically supported on an outer peripheral surface of a heating roller while coming into surface contact with the outer peripheral surface. The pressure member serves to grind the outer peripheral surface of the heating roller, to maintain a surface roughness of the heating roller at a predetermined level or less.

### CROSS-REFERENCE TO RELATED APPLICATIONS

This application claims the benefit of priority under 35 U.S.C §119(a) from Korean Patent Application No. 2009-0082414, filed on Sep. 2, 2009 in the Korean Intellectual Property Office, the disclosure of which is incorporated herein in its entirety by reference.

### BACKGROUND

1. Field of the Invention

Embodiments of the present general inventive concept relate to an image forming apparatus having a fusing unit to fuse developer to a printing medium.

2. Description of the Related Art

Image forming apparatuses are devised to form an image on a printing medium according to inputted image signals. Examples of image forming apparatuses include printers, copiers, facsimiles, and devices combining functions thereof.

An image forming apparatus includes, e.g., a body defining an outer appearance of the image forming apparatus, a printing medium storage unit in which a plurality of printing media is stored, a developing unit to develop an electrostatic latent image into a visible image by applying developer to the electrostatic latent image, an exposure unit to form an electrostatic latent image on a photosensitive body of the developing unit, a fusing unit to fuse developer, that has been transferred to a printing medium, onto the printing medium, and a discharge unit to discharge a printing medium, on which an image has been completely formed, to an outside of the body.

Accordingly, after an electrostatic latent image is formed on a surface of the photosensitive body of the developing unit as light scans the photosensitive body that has been electrically charged, developer is fed to the electrostatic latent image formed on the photosensitive body, developing the electrostatic latent image into a visible image. Subsequently, the visible image formed on the photosensitive body is transferred to a printing medium supplied from the printing medium storage unit and in turn, the transferred image on the printing medium is fused onto the printing medium while passing through the fusing unit. In this way, formation of an image on the printing medium is completed. The printing medium, on which the image has been completely formed, is discharged out of the body via the discharge unit.

Of the above mentioned constituent elements of the image forming apparatus, the fusing unit includes a heating roller, a press roller elastically supported on an outer surface of the heating roller, and a pair of discharge rollers to discharge a printing medium, on which an image has been completely fused, from the fusing unit. Accordingly, as a printing medium containing transferred developer passes between the heating roller and the press roller, the developer is fused onto the printing medium by heat and pressure applied by the heating roller and the press roller. Thereafter, the printing medium is discharged out of the fusing unit by passing between the pair of discharge rollers.

### SUMMARY

The present general inventive concept provides a fusing unit to reduce and/or prevent damage to an outer surface of a heating roller due to use for a long period of time and consequently, to reduce and/or prevent deterioration in an image quality, and an image forming apparatus having the same.

Additional features and/or utilities of the present general inventive concept will be set forth in part in the description which follows and, in part, will be obvious from the description, or may be learned by practice of the general inventive concept.

Features and/or utilities of the present general inventive concept may be achieved by providing a fusing unit which includes a heating roller, a press roller to press a printing medium toward the heating roller, and a pressure member to apply a face pressure (i.e., a force) to an outer peripheral surface of the heating roller to enable grinding of the outer peripheral surface.

The pressure member may extend parallel to a shaft of the heating roller to have a length at least equal to or greater than a width of the printing medium.

The pressure member may extend parallel to a shaft of the heating roller to have a length at least equal to or greater than a length of the heating roller.

An end of the pressure member may extend in a rotating direction of the heating roller so that a portion of the end is supported on the outer peripheral surface of the heating roller.

The pressure member may be formed of an elastically deformable plate and may be elastically supported on the heating roller while being kept bent.

A plurality of pressure members may be spaced apart from one another along a circumferential direction of the heating roller.

The pressure member may be formed of a metal plate, and the fusing unit may further include a temperature sensor installed onto the pressure member to measure a temperature of the heating roller.

The pressure member may be formed of an elastically deformable plate and may be bent arcuately (e.g., shaped in an arc) to be elastically supported on the outer peripheral surface of the heating roller, and the fusing unit may further include supporting members coupled to both ends of the bent pressure member to keep the pressure member in the bent posture (e.g., the arc shape).

The pressure member may be formed of a rod shape having a circular cross section.

The fusing unit may further include a drive roller to rotate a belt having a first side installed onto the pressure member and a second side installed onto the drive roller.

A surface of the belt may contact a face of the outer peripheral surface of the heating roller.

Features and/or utilities of the present general inventive concept may also be achieved by providing an image forming apparatus which includes a fusing unit to fuse developer disposed on a printing medium onto the printing medium, wherein the fusing unit includes a heating roller, a press roller to press the printing medium toward the heating roller, and a pressure member to apply a face pressure (i.e., a force) to an outer peripheral surface of the heating roller to enable grinding of the outer peripheral surface.

Features and/or utilities of the present general inventive concept may also be achieved by providing a pressure member assembly usable with an image forming apparatus having a heating roller and a pressure roller to press a printing medium toward the heating roller, the pressure member assembly including a pressure member having a first portion in contact with a surface of the heating roller and a second portion supported within the image forming apparatus such that the first portion provides a constant elastic force against the surface of the heating roller.

The pressure member may be arc-shaped such that the second portion is spaced apart from the surface of the heating roller.

The pressure member may be formed of an elastic material.

The surface of the heating roller may be coated with a polymer layer.

The constant elastic force may be adjustable to maintain a desired surface roughness of the heating roller. The constant elastic force may be about 200 mPa.

Features and/or utilities of the present general inventive concept may also be achieved by providing a pressure member assembly usable with an image forming apparatus having a heating roller which includes a support member disposed adjacent to the heating roller, and a plurality of pressure members coupled to the support member such that a surface of each of the pressure member generates a force against a surface of the heating roller to remove impurities disposed thereon.

The force may be adjustable to achieve a desired surface roughness of the heating roller.

The plurality of pressure members may be integrally formed with each other.

The plurality of pressure members may be formed of an elastic material in an arc-shape.

The plurality of pressure members may be formed of a thermally conductive material to transmit heat to the heating roller.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a sectional view illustrating a schematic configuration of an image forming apparatus according to an exemplary embodiment of the present general inventive concept;

FIG. 2 is a schematic view of a fusing unit usable with an image forming apparatus according to an exemplary embodiment of the present general inventive concept;

FIG. 3 is a perspective view of a heating roller and a pressure member illustrated in FIG. 2;

FIG. 4 is a schematic view of the pressure member illustrated in FIG. 3;

FIG. 5 is a schematic view of a fusing unit usable with an image forming apparatus according to an exemplary embodiment of the present general inventive concept;

FIG. 6 is a schematic view of a fusing unit usable with an image forming apparatus according to an exemplary embodiment of the present general inventive concept;

FIG. 7 is a schematic view of a fusing unit usable with an image forming apparatus according to a an exemplary embodiment of the present general inventive concept;

FIG. 8 is a schematic view of a fusing unit usable with an image forming apparatus according to an exemplary embodiment of the present general inventive concept; and

FIG. 9 is a schematic view of a fusing unit usable with an image forming apparatus according to an exemplary embodiment of the present general inventive concept.

### DETAILED DESCRIPTION OF THE EMBODIMENTS

Reference will now be made in detail to an image forming apparatus according to the embodiments of the present general inventive concept, examples of which are illustrated in the accompanying drawings, wherein like reference numerals refer to the like elements throughout. The embodiments are described below in order to explain the present general inventive concept by referring to the figures.

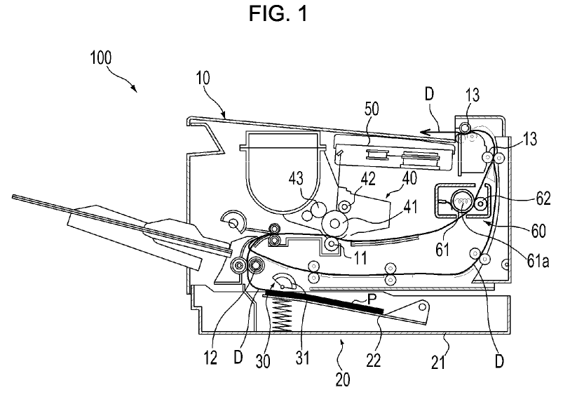

As illustrated in FIG. 1, an image forming apparatus 100 according to an exemplary embodiment of the present general inventive concept includes a body 10 which defines an outer appearance of the image forming apparatus 100, a printing medium storage unit 20, a pickup unit 30, a developing unit 40, an exposure unit 50, and a fusing unit 60. The printing medium storage unit 20 may be removably installed in the body 10 and stores printing media P, such as paper, therein to supply the printing media P to the developing unit 40. The pickup unit 30 can be used to pick up the printing media P stored in the printing medium storage unit 20 sheet by sheet. The developing unit 40 can serve to form a visible image on each printing medium P supplied via the pickup unit 30 by use of developer. The exposure unit 50 can serve to form an electrostatic latent image on a photosensitive body 41 of the developing unit 40. The fusing unit 60 can serve to fuse developer, which has been transferred to a printing medium P, onto the printing medium P, to thereby complete an image formation operation.

The printing medium storage unit 20 includes a printing medium cassette 21 and a knock-up plate 22. The printing medium cassette 21 may be installed in the body 10 so as to be movable in a first direction and a second direction (i.e., forward and reward directions) to be pulled out or pushed into the body 10, similar to a drawer. The knock-up plate 22 can be installed in the printing medium cassette 21 to load a plurality of printing media P thereon.

The pickup unit 30 picks up an uppermost one of the printing media P stored in the printing medium storage unit 20 and delivers the printing media P to the developing unit 40 sheet by sheet. The pickup unit 30 includes a pickup roller 31, which is adapted to come into frictional contact with a printing medium P stored in the printing medium storage unit 20 during a rotation of the pickup roller 31, thereby functioning to pick up the printing medium P.

The developing unit 40 can form a visible image on a printing medium P delivered from the printing medium storage unit 20 by use of developer, such as toner. The developing unit 40 includes the photosensitive body 41 to serve as an image carrier, on a surface of which an electrostatic latent image is formed by the exposure unit 50, a charging roller 42 to electrically charge the photosensitive body 41, and a developing roller 43 to develop the electrostatic latent image formed on the photosensitive body 41 into a visible image.

The exposure unit 50 forms an electrostatic latent image on the photosensitive body 41 by scanning light, which may contain image information, onto the photosensitive body 41.

In addition, a transfer roller 11, an alignment roller 12, and a plurality of discharge rollers 13 are installed in the body 10. The transfer roller 11 can be arranged opposite to the photosensitive body 41 and can transfer a visible image formed on the photosensitive body 41 to a printing medium P by pressing the printing medium P toward the photosensitive body 41. The alignment roller 12 can be used to align a front end of a printing medium P picked up by the pickup roller 31. The plurality of discharge rollers 13 is successively arranged along a movement path D of a printing medium P, on which an image has been completely formed, and can be used to discharge the printing medium P, having passed through the fusing unit 60, to an outside of the body 10.

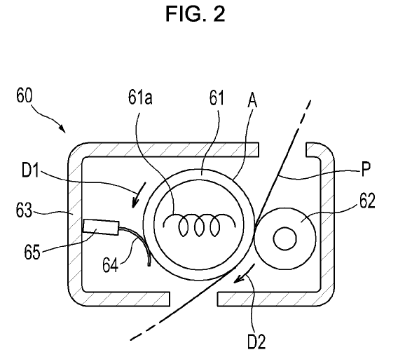

The fusing unit 60 fuses developer onto a printing medium P by applying heat and/or pressure to the printing medium P. The fusing unit 60, as illustrated in FIG. 2, includes a heating roller 61 in which a heater 61a is received, and a press roller 62 elastically supported on an outer peripheral surface of the heating roller 61 to press a printing medium P toward the heating roller 61. A fusing case 63 encloses the heating roller 61 and the press roller 62 and may define an outer appearance of the fusing unit 60. The heating roller 61 and the press roller 62 may be rotatably installed within the fusing case 63.

In exemplary embodiments, the fusing unit 60 may further include a pressure member 64, to maintain a surface roughness of the heating roller 61 at a predetermined level or less. In the present exemplary embodiment, the pressure member 64 is made of an elastically deformable material, one side of which is elastically supported on the heating roller 61 while coming into surface contact with an outer peripheral surface A of the heating roller 61 in order to apply a face pressure to at least a partial region of the outer peripheral surface A of the heating roller 61.

The outer peripheral surface A of the heating roller 61 can be formed of a perfluoroalkoxy copolymer layer, and to prevent damage to the perfluoroalkoxy copolymer layer of the outer peripheral surface A of the heating roller 61, the pressure member 64 is adapted to press against the outer peripheral surface A of the heating roller 61 by a pressure of approximately 200 mPa. However, the present general inventive concept is not limited thereto. That is, in exemplary embodiments, a force applied by the pressure member 64 onto the heating roller 61 may be adjusted to correspond to a force required to remove impurities, such as developer, from the heating roller 61. In exemplary embodiments, providing the press member 64 to be elastically supported on the outer peripheral surface A of the heating roller 61 in order to apply a face pressure to the outer peripheral surface A of the heating roller 61 has an effect of grinding the outer peripheral surface A of the heating roller 61 and of removing impurities or developer which remain on the surface of the heating roller 61. Accordingly, the outer peripheral surface A of the heating roller 61 may maintain a surface roughness at a predetermined level or less even after being used for a long period of time.

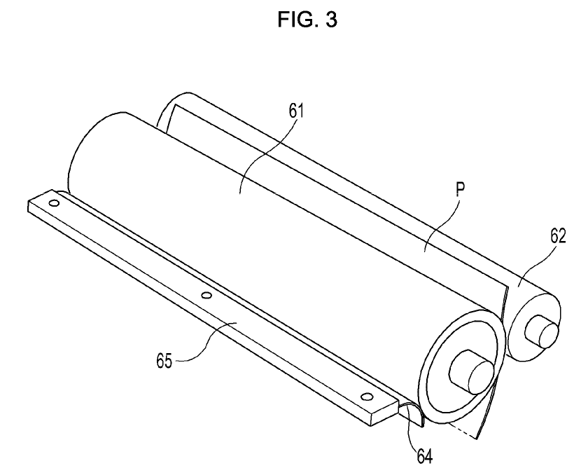

In exemplary embodiments, the pressure member 64, as illustrated in FIG. 3, takes the form of a plate, a front end of which extends in a rotating direction D1 of the heating roller 61, so that the front end is elastically bent to come into surface contact with a partial region of the outer peripheral surface A of the heating roller 61. A supporting member 65 can be coupled to a rear end of the pressure member 64 and can be used to support and fixedly couple the rear end of the pressure member 64 to the fusing case 63. With this installation of the pressure member 64, for example, it may be possible to prevent a front end edge of the pressure member 64 from scratching or damaging the outer peripheral surface A of the heating roller 61. Moreover, even if the heating roller 61 is unintentionally rotated in a reverse direction D2 during an assembly operation of the fusing unit 60, the pressure member 64 is maintained to continuously come into surface contact with the outer peripheral surface A of the heating roller 61, while causing no damage to the heating roller 61.

The pressure member 64 lengthily extends in an axial direction of the heating roller 61, to have a length at least equal to or greater than a width of a printing medium P. This axially extending pressure member 64 may allow the outer peripheral surface A of the heating roller 61 to have a grinding effect over a wider area than a passage area of the printing medium P. That is, in exemplary embodiments, the pressure member 64 may extend along the axial direction of the heating roller 61 to have a length which is equal to or greater than a length of an area through which the printing medium P passes in between the heating roller 61 and the press roller 62.

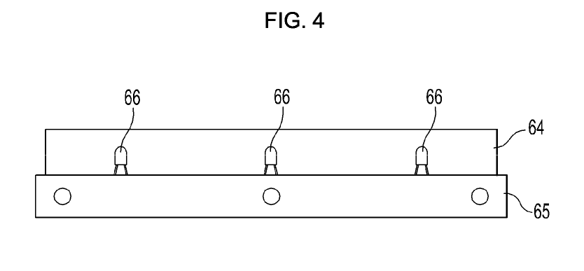

In exemplary embodiments, the pressure member 64 can be formed of a metal plate to easily transmit heat to the heating roller 61. However, the present general inventive concept is not limited thereto. That is, in exemplary embodiments, the pressure member 64 can be formed of various other thermally conductive materials. In exemplary embodiments, temperature sensors 66 may be arranged on a surface of the pressure member 64, as illustrated in FIG. 4. In the present exemplary embodiment, the pressure member 64 is formed of a stainless steel plate having a Teflon™ (e.g., polytetrafluoroethylene) coated on an outer surface thereof, and the plurality of temperature sensors 66 can be spaced apart from one another in the axial direction of the heating roller 61 on the surface of the pressure member 64. Accordingly, the heater 61a in the heating roller 61 may be controlled based on a temperature measured by the temperature sensors 66.

Although the present exemplary embodiment describes the pressure member 64 as extending by a length greater than a width of the printing medium P, to thereby realize a grinding effect of the pressure member 64 throughout a length of the heating roller 61, the pressure member 64 may extend in the axial direction of the heating roller 61 so that the length of the pressure member 64 may be equal to or greater than that of the heating roller 61.

In addition, although the present exemplary embodiment describes the pressure member 64 as being formed of a metal plate to easily transmit heat from the heating roller 61 to the temperature sensor 66, the pressure member 64 may be made of an elastically deformable and highly polymerized material, such as polyimide, etc., if there is no temperature sensor 66 disposed on the pressure member 64.

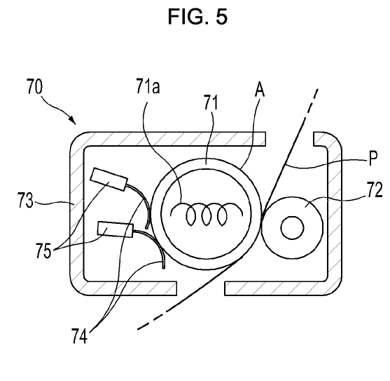

FIG. 5 illustrates a fusing unit 70 according to an exemplary embodiment of the present general inventive concept.

As illustrated in FIG. 5, a pair of pressure members 74 and a pair of supporting members 75 to support the pressure members 74 are circumferentially spaced apart from one another, so that the pair of pressure members 74 come into surface contact with two locations of an outer peripheral surface of a heating roller 71 to apply a face pressure to the heating roller 71. In exemplary embodiments, pressing against the two locations of the outer peripheral surface of the heating roller 71 by using the pair of pressure members 74 may increase a grinding efficiency with respect to the outer peripheral surface A of the heating roller 71. However, the present general inventive concept is not limited thereto. That is, in exemplary embodiments, the pressure members 74 may contact the outer peripheral surface A of the heating roller 71 at more than two locations.

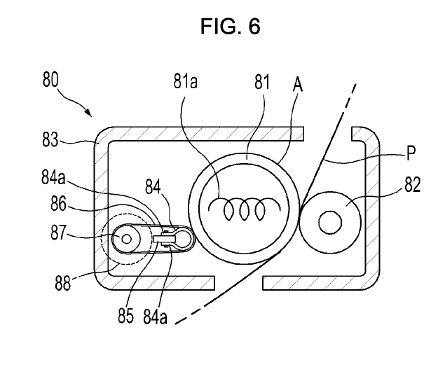

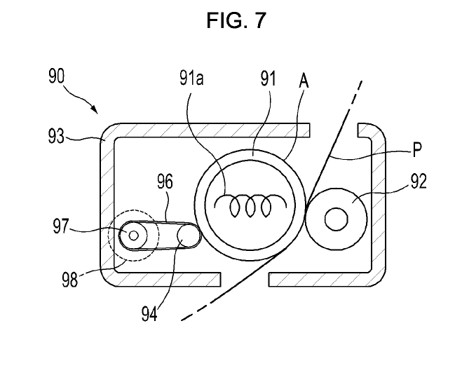

FIG. 6 illustrates a fusing unit 80 according to an exemplary embodiment of the present general inventive concept. FIG. 7 is a schematic view of a fusing unit 90 usable with an image forming apparatus according to an exemplary embodiment of the present general inventive concept.

The fusing unit 80 includes a heating roller 81, having a heater 81a disposed therein, and a press roller 82 arranged opposite to each other within a fusing case 83, a pressure member 84 to apply a face pressure to an outer peripheral surface A of the heating roller 81 so as to grind the outer peripheral surface A of the heating roller 81, and a supporting member 85 to support the pressure member 84 to the fusing case 83.

In exemplary embodiments, to prevent impurities, such as paper dust or developer from being trapped between the heating roller 81 and the pressure member 84, the fusing unit 80 may further include a drive motor 88 to generate a rotation power, a drive roller 87 to be rotated by the drive motor 88, and a loop-shaped belt 86, one side of which is supported on the drive roller 87 and the other side of which is supported on the pressure member 84.

In exemplary embodiments, the pressure member 84 can be formed of an elastically deformable plate and may be bent to have an arc-shaped cross section. This shape has the effect of assisting the belt 86 to easily move along an outer surface of the pressure member 84. A bent region of the pressure member 84 can be supported on the outer peripheral surface A of the heating roller 81 with the belt 86 interposed therebetween, to thereby apply a face pressure onto the outer peripheral surface A of the heating roller 81. Also, both distal ends 84a of the bent pressure member 84 can be supported respectively on the supporting member 85, so that the pressure member 84 may be kept bent via the supporting members 85.

In exemplary embodiments, the drive roller 87 can be periodically rotated by the drive motor 88, such that the belt 86 continuously moves a section of the belt 86 arranged between the heating roller 81 and the pressure member 84. Accordingly, even if impurities are trapped between the heating roller 81 and the pressure member 84, the impurities may be rapidly released from between the heating roller 81 and the pressure member 84 via a movement of the belt 86.

Although the exemplary embodiment illustrated in FIG. 6 describes the pressure member 84 as being formed of an arcuately bent plate, in the exemplary embodiment illustrated in FIG. 7, a pressure member 94 may take the form of a rod having a circular cross section, and a belt 96 can be wound on the pressure member 94. Accordingly, the pressure member 94 may act to apply a face pressure to an outer peripheral surface A of a heating roller 91 via the belt 96 interposed therebetween.

Although the exemplary embodiments illustrated in FIGS. 6 and 7 illustrate the belts 86 and 96 as being interposed between the heating rollers 81 and 91 and the pressure members 84 and 94, the belts 86 and 96 may serve as additional elements to prevent developer from being trapped between the heating rollers 81 and 91 and the pressure members 84 and 94. Therefore, in alternative exemplary embodiments, the pressure members 84 and 94 may come into direct contact with the outer peripheral surfaces A of the heating rollers 81 and 91 to thereby apply a face pressure to the heating rollers 81 and 91, without using the belts 86 and 96.

In addition, although the above described exemplary embodiments describe the pressure members 64, 74, and 84 as being formed of an elastically deformable material, this is devised to allow the pressure members 64, 74, 84 to more easily apply a face pressure onto the heating roller 61, 71, 81 by coming into surface contact with the outer peripheral surface A of the heating roller 61, 71, 81. Therefore, in exemplary embodiments, the pressure member 64, 74, 84 may be made of a non-elastic deformable material, similar to the rod-shaped pressure member 94. However, the present general inventive concept is not limited thereto. That is, in exemplary embodiments, the pressure member 64, 74, 84 may be formed in various shapes to provide an elastic force onto an outer peripheral surface of the heating roller 61, 71, and 81 to thereby remove impurities, such as developer, from the outer peripheral surface A of the heating roller 61, 71, and 81.

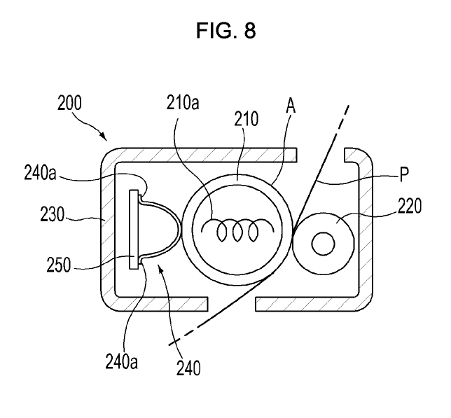

FIG. 8 illustrates a fusing unit 200 according to an exemplary embodiment of the present general inventive concept.

The fusing unit 200 includes a heating roller 210, having a heater 210a disposed therein, and a press roller 220 arranged opposite to each other within a fusing case 230, a pressure member 240 coupled to the fusing case 230 via a support member 250. In exemplary embodiments, the distal ends 240a of the pressure member 240 are coupled to the support member such that a portion of the pressure member 240 applies an elastic force against an outer peripheral surface A of the heating roller 210 to thereby maintain a desired surface roughness of the heating roller 210. The pressure member 240 may be formed in an arc-shape which contacts the outer peripheral surface A of the heating roller 210.

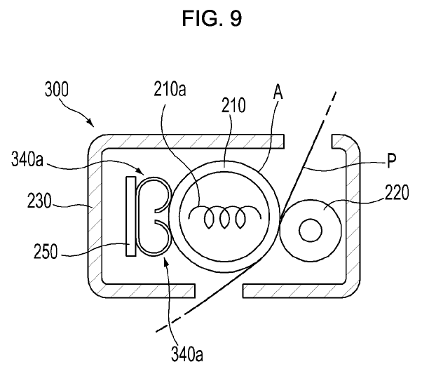

FIG. 9 illustrates a fusing unit 300 according to an exemplary embodiment of the present general inventive concept.

The fusing unit 300 includes substantially similar components of the exemplary embodiment illustrated in FIG. 8, except for a pressure member 340 which is formed of an elastic material such that distal ends 340a thereof contact two locations of an outer peripheral surface A of the heating roller 210. That is, the pressure member 340 may be integrally formed from a single piece of material such that the distal ends 340a form arcs which contact the outer peripheral surface A of the heating roller 210. The pressure member 340 is coupled to the fusing case 230 such that the distal ends 340a provide a constant force against two portions of the outer peripheral surface A of the heating roller 210 while the heater roller 210 is rotated in a forward or reverse direction. The distal ends 340a may be spaced apart from the outer peripheral surface A of the heating roller 210 to prevent causing damage to the heater roller 210.

As apparent from the above description, according to the exemplary embodiments of the present general inventive concept, a pressure member applies a face pressure to an outer surface of a heating roller, to cause grinding of the outer surface of the heating roller. This has the effect of reducing and/or preventing an increase in surface roughness of the heating roller despite being used for a long period of time and consequently, minimizing and/or preventing a deterioration in an image quality of the image forming apparatus.

Although some exemplary embodiments of the present general inventive concept have been illustrated and described, it would be appreciated by those skilled in the art that changes may be made in these exemplary embodiments without departing from the principles and spirit of the present general inventive concept, the scope of which is defined in the claims and their equivalents.

What is claimed is:

1. A fusing unit comprising:
a heating roller;
a press roller to press a printing medium toward the heating roller; and
a pressure member to apply a face pressure to an outer peripheral surface of the heating roller to enable grinding of the outer peripheral surface.

2. The fusing unit according to claim 1, wherein the pressure member extends parallel to a shaft of the heating roller to have a length at least equal to or greater than a width of the printing medium.

3. The fusing unit according to claim 1, wherein the pressure member extends parallel to a shaft of the heating roller to have a length at least equal to or greater than a length of the heating roller.

4. The fusing unit according to claim 1, wherein an end of the pressure member extends in a rotating direction of the heating roller so that a portion of the end is supported on the outer peripheral surface of the heating roller.

5. The fusing unit according to claim 4, wherein the pressure member is formed of an elastically deformable plate and is elastically supported on the heating roller while being kept bent.

6. The fusing unit according to claim 1, wherein a plurality of pressure members is spaced apart from one another along a circumferential direction of the heating roller.

7. The fusing unit according to claim 1, wherein the pressure member is formed of a metal plate, and the fusing unit further comprises a temperature sensor installed onto the pressure member to measure a temperature of the heating roller.

8. The fusing unit according to claim 1, wherein the pressure member is formed of an elastically deformable plate and is shaped in an arc to be elastically supported on the outer peripheral surface of the heating roller, and the fusing unit further comprises supporting members coupled to both ends of the pressure member to keep the pressure member in the arc shape.

9. The fusing unit according to claim 1, wherein the pressure member is formed in a rod shape having a circular cross section.

10. The fusing unit according to claim 1, further comprising a drive roller to rotate a belt having a first side installed onto the pressure member and a second side installed onto the drive roller.

11. The fusing unit according to claim 10, wherein a surface of the belt contacts a face of the outer peripheral surface of the heating roller.

12. An image forming apparatus comprising:
a fusing unit to fuse developer disposed on a printing medium onto the printing medium, wherein the fusing unit includes a heating roller, a press roller to press the printing medium toward the heating roller, and a pressure member to apply a face pressure to an outer peripheral surface of the heating roller to enable grinding of the outer peripheral surface.

13. The image forming apparatus according to claim 12, wherein the pressure member is made of an elastically deformable material, so that a distal end of the pressure member extends in a rotating direction of the heating roller so as to be elastically supported on the outer peripheral surface of the heating roller.

14. The image forming apparatus according to claim 12, wherein the pressure member is formed of an elastically deformable plate and is shaped in an arc to be elastically supported on the outer peripheral surface of the heating roller, and the image forming apparatus further comprises supporting members coupled to both ends of the pressure member to keep the pressure member in the arc shape.

15. The image forming apparatus according to claim 12, wherein the pressure member takes the form of a rod having a circular cross section.

16. The image forming apparatus according to claim 12, further comprising a drive roller to be driven upon receiving rotation power, and a belt one side of which is installed to the pressure member and the other side of which is installed to the drive roller.

17. A pressure member assembly usable with an image forming apparatus having a heating roller and a pressure roller to press a printing medium toward the heating roller, comprising:
a pressure member having a first portion in contact with a surface of the heating roller and a second portion supported within the image forming apparatus such that the first portion provides a constant elastic force against the surface of the heating roller.

18. The pressure member assembly of claim 17, wherein the pressure member is arc-shaped such that the second portion is spaced apart from the surface of the heating roller.

19. The pressure member assembly of claim 17, wherein the pressure member is formed of an elastic material.

20. The pressure member assembly of claim 17, wherein the surface of the heating roller is coated with a polymer layer.

21. The pressure member assembly of claim 20, wherein the constant elastic force is adjustable to maintain a desired surface roughness of the heating roller.

22. The pressure member assembly of claim 21, wherein the constant elastic force is about 200 mPa.

23. A pressure member assembly usable with an image forming apparatus having a heating roller, comprising:
a support member disposed adjacent to the heating roller; and
a plurality of pressure members coupled to the support member such that a surface of each of the pressure member generates a force against a surface of the heating roller to remove impurities disposed thereon.

24. The pressure member assembly of claim 23, wherein the force is adjustable to achieve a desired surface roughness of the heating roller.

25. The pressure member assembly of claim 23, wherein the plurality of pressure members are integrally formed with each other.

26. The pressure member assembly of claim 23, wherein the plurality of pressure members are formed of an elastic material in an arc-shape.

27. The pressure member assembly of claim 23, wherein the plurality of pressure members are formed of a thermally conductive material to transmit heat to the heating roller.
